(19) United States
(12) Patent Application Publication
(10) Pub. No.: US 2001/0009238 A1
(43) Pub. Date: Jul. 26, 2001

(54) WATER RESISTIVITY CONTROL SYSTEM

(75) Inventors: JOHN A. MOSHEIM, MAYFIELD HEIGHTS, OH (US); WILLIAM S. BANHAM, TWINSBURG, OH (US)

Correspondence Address: WATTS HOFFMANN FISHER & HEINKE CO, P O BOX 99839, CLEVELAND, OH, 441990839

(73) Assignee: KINETICO INCORPORATED

(21) Appl. No.: 09/165,055

(22) Filed: Oct. 2, 1998

(51) Int. Cl. C02F 1/00

(52) U.S. Cl. 210/746; 210/900; 261/76; 261/77

(57) ABSTRACT

Apparatus and method for controlling the resistivity of water. The apparatus includes a diffuser injector for mixing water and a water soluble gas such as carbon dioxide gas and that defines an inlet conduit through which water to be treated is communicated and an output conduit from which treated water is discharged. A diffuser tube is disposed within one of the conduits for injecting carbon dioxide gas into the water. A proportional control valve provides carbon dioxide gas from a carbon dioxide tank to the carbon dioxide diffuser tube. Downstream from the diffuser injector are a static mixer for further intermingling the water and carbon dioxide gas and a serially connected contact chamber for enhancing the stability in the resistivity level of the water. A resistivity monitor measures the resistivity of the water and carbon dioxide mixture and transmits a signal to a controller. The controller receives and converts the signals transmitted by the resistivity monitor and sends a corrective signal to the proportional control valve to proportionately adjust the injection rate of carbon dioxide gas into the diffuser injector.

### FIELD OF THE INVENTION

The present invention relates to a water resistivity control system and, in particular, to an apparatus and method for dissolving carbon dioxide (CO₂) gas into ultrapure water.

### BACKGROUND ART

The control of resistivity in ultrapure water is particularly important in such industries as the manufacturing of semiconductors. If, for example, water having a high resistivity is used for dicing or jet rinsing semiconductor wafers, then the wafer may attract foreign particles or be subject to static electricity build-up which can damage the wafer. Some systems, for example as disclosed in U.S. Pat. No. 5,264,025 issued to Asai et al, utilize a membrane for dissolving carbon dioxide gas into the water to control the level of resistivity. This system and others like it have not been totally satisfactory.

### SUMMARY OF THE INVENTION

The present invention provides a new and improved method and apparatus for controlling the resistivity of water. The system is especially adapted to control the resistivity of ultrapure water which has many applications in industry, such as the manufacturing of semiconductors.

According to the preferred embodiment, the water resistivity control system defines a flow path extending from an inlet to an outlet. An injector/diffuser unit is disposed in the flow path and is operative to inject CO₂ gas into water flowing through the unit. A sensor monitors the resistivity of water flowing at a location downstream of the diffuser/ejector unit and, in response to signals received from the resistivity sensor, controls the flow of CO₂ gas into the injector/diffuser unit as a function of the resistivity measured at the downstream location. According to this embodiment, the injector/diffuser unit includes a porous member through which the CO₂ gas is injected into the water flowing through the unit. In the preferred embodiment, the member comprises a porous tube having an axis that is substantially parallel to an axis of a passage defined by the injector/diffuser unit through which the water flows.

According to another preferred embodiment of the invention, the water resistivity control system includes an injector/diffuser unit that is disposed in the flow path through which CO₂ gas is injected into water being treated. A mixer is located downstream from the injector/diffuser unit and is in serial communication. The mixing unit promotes dissolving of the CO₂ gas into the water. One type of mixer that may form part of the mixing unit, a static mixer which includes elements that promote turbulence in the flowing water, thus promoting dissolving of the CO₂ gas. In another embodiment, a contact chamber forms part of the mixing unit and, in the preferred embodiment, comprises a tank having an inlet and an outlet that is at least partially filled with an inert material that operates to obstruct or impede the flow of water so that the water and CO₂ gas mixture travels in a circuitous path. This increases the time for dissolving the CO₂ gas into the water.

According to a feature of the invention, the controller is attached to a proportional valve that controls the fluid communication between a source of CO₂ gas and the injector/diffuser unit. The controller adjusts the proportional valve to vary the flow rate of CO₂ gas as a function of the resistivity measured.

According to a feature of the invention, the water resistivity control system includes a flow switch for detecting a predetermined minimum flow of water. The flow switch is used to signal the controller in order to activate the CO₂ injector/diffuser unit. When the flow of water falls below a predetermined level, the injection of CO₂ gas is terminated.

Additional features of the invention will become apparent and a fuller understanding obtained by reading the following detailed description made in connection with the accompanying drawings.

### BRIEF DESCRIPTION OF THE DRAWINGS

FIG. 1 is a schematic diagram showing a water resistivity control system constructed in accordance with the present invention; and

FIG. 2 is a cross-sectional view of the diffuser injector shown in the schematic diagram of FIG. 1.

### BEST MODE FOR PRACTICING THE INVENTION

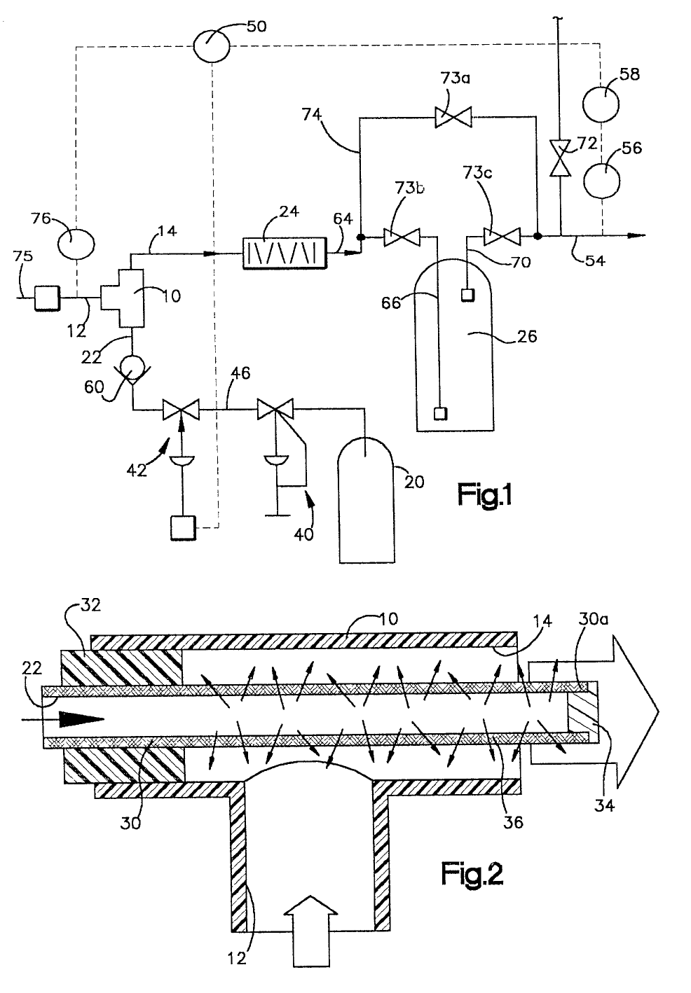

FIGS. 1 through 2 schematically illustrate a preferred construction of a water resistivity control system embodying the present invention. The system includes a carbon dioxide diffuser injector 10 having an input conduit 12 through which water to be treated is communicated and an output conduit 14 from which water that is mixed with carbon dioxide gas is discharged. The diffuser injector 10 is most preferably made of polyvinyl chloride (PVC). Carbon dioxide gas is introduced into the diffuser injector 10 from a carbon dioxide source tank 20 by means of carbon dioxide input conduit 22. The discharged water is communicated to a static mixer 24 and a contact chamber 26 where additional mixing and dissolving of carbon dioxide occur.

As shown in FIG. 2, the carbon dioxide diffuser injector 10 is generally T-shaped so that the water input conduit 12 forms a right angle relative to the output conduit 14. This arrangement facilitates turbulence within the diffuser injector 10. A porous thermoplastic diffuser tube 30, preferably made of a high density polyethylene material, is secured in one leg of the T-shaped diffuser injector 10 by an insert 32 preferably made of PVC. Both the insert 32 and the diffuser injector 10 may be made of other typical materials of construction for reionizer components, such as polypropylene (PP), polytetrafluoroethylene (PTFE), polyvinylidene fluoride (PVDF), or chlorinated polyvinyl chloride (CPVC). The length and diameter of the diffuser tube 30 can vary depending on the particular application, the flow and pressure of the incoming water, the carbon dioxide gas pressure, and the required product resistivity. The diffuser tube 30 defines a plurality of microporous openings 36 that disperse and diffuse fine amounts of carbon dioxide gas into the water flowing through the diffuser injector 10. An end cap 34 is attached to the distal end 30a of the diffuser tube 30 to prevent carbon dioxide gas from flowing therefrom and to force the gas to flow through the micropores 36 of the diffuser tube 30.

As can be seen in FIG. 2, the porous diffuser tube 30 is disposed transverse the input conduit 12 and coaxially with respect to the output conduit 14. Incoming water collides with the porous diffuser tube 30 and creates additional turbulence within the diffuser injector 10. The diffuser tube 30 is positioned and immersed within the diffuser injector 10 such that carbon dioxide gas emitted from its pores 36 dispersed into the incoming water in a region of relatively high turbulence. The streams of carbon dioxide gas may also create additional turbulence and facilitate mixing in the diffuser injector 10.

As shown in FIG. 1, carbon dioxide gas is communicated through a pressure regulator, generally indicated by the reference character 40, and a proportional control valve, generally indicated by the reference character 42, before being communicated to the diffuser injector 10 via conduit 22. The pressure regulator 40 maintains the carbon dioxide gas exiting the carbon dioxide source tank 20 at a substantially constant pressure. The proportional control valve 42 is operable to meter the flow of carbon dioxide gas communicated from the pressure regulator 40 and conduit 46.

The proportional control valve 42 is controlled by a proportional integral differential (PID) controller 50. The PID controller 50 adjusts the proportional control valve 42 in proportion to changes in the product quality, or resistivity, of the water that exits conduit 54 of the system. A resistivity monitor 56 continuously measures the resistivity of the water exiting the system at conduit 54. If the resistivity is higher or lower than a predetermined set point, then a transmitter 58 transmits a signal to the PID controller 50 which, in turn, sends a corrective signal to the proportional control valve 42. The proportional control valve 42 then adjusts the flow rate of carbon dioxide communicated into the diffuser injector 10. A check valve 60 is disposed intermediate the proportional control valve 42 and the carbon dioxide input conduit 22. The check valve 60 permits flow from the proportional control valve 42 to the diffuser injector 10 but prevents reverse flow.

Discharged water from output conduit 14 is communicated to a serially connected static mixer 24 and contact chamber 26 where additional mixing and dissolving of carbon dioxide occur. The static mixer 24 creates turbulence and further intermingles the water and carbon dioxide gas, thereby producing a substantially homogenous mixture. The reionized water is communicated from the static mixer 24 to the contact chamber 26 via conduit 64. The water is discharged at the bottom of the contact chamber by an internal tank conduit 66. The contact chamber 26 buffers the reionized water and further enhances stability in the resistivity level of the water. The volume of the contact chamber 26 is sized such that carbon dioxide bubbles entering the contact chamber 26 dissolve before exiting the contact chamber 26. The chamber 26 contains a thermoplastic media, preferably polypropylene beads, that promotes mixing. Thus, incoming water enters at the bottom of the chamber 26 via input conduit 66 and is expelled from the top of the tank via output conduit 70. Air from outside the water resistivity control system and carbon dioxide bubbles may accumulate at the top of the chamber 26. A manually operated valve 72 is located above the level of the contact chamber 26 to vent off, or depressurize, at start-up or service, any accumulated air or carbon dioxide gas contained in the top of the contact chamber 26. An arrangement of manually operated valves 73a, 73b, 73c provides serviceability of the contact chamber 26. In the event the contact chamber 26 requires repair or replacement, the by-pass valve 73a can be opened, and input valve 73b and output valve 73c closed so that water is communicated from conduit 64 to conduit 54 via by-pass conduit 74.

The water resistivity control system constructed in accordance with the present invention operates as follows. Water having a particular resistivity, for example greater than 5 MegOhm, enters the system via water supply conduit 75. The water enters the system at a constant flow rate and pressure, for example at 20 gallons per minute and 60 psi. A flow detection switch 76, upon detecting flow of water through conduit 75, turns the water resistivity control system in the “on” mode. The water flows through, and is reionized by, the diffuser injector 10, the static mixer 24 and the contact chamber 26 before exiting conduit 54 at which point the resistivity monitor 56 measures the resistivity of the water. If the measured resistivity is in excess of a predetermined set point value, for example 1.25 MegOhm, then the transmitter 58 sends a signal in the range of 4-20 mA that is a function of the measured resistivity to the PID controller 50. The PID controller 50, in turn, sends a corrective signal to the proportional control valve 42 to proportionately adjust the injection rate of carbon dioxide into the diffuser injector 10. The pressure of the carbon dioxide gas is predetermined by the value set according to the pressure regulator 40, for example, about 100 psi. The carbon dioxide gas is metered into the intersection, or high turbulent, region of the T-shaped diffuser injector 10 where it is effectively brought into contact with the flowing water. The carbon dioxide gas and the water react to produce conductive ions, which, as is known in the art, reduces water resistivity. The carbon dioxide gas is dissolved into the water and the water is reionized. The reionized water is then communicated to the static mixer 24 and contact chamber 26 to assure complete mixing and dissolution of the carbon dioxide. The resistivity monitor 56 continues to monitor the reionized water, and maintain a steady supply of carbon dioxide to the water, until the resistivity is substantially equal to the predetermined set point value, for example, 1 MegOhm +/−0.25 MegOhm, at which point in time the resistivity monitor 56 signals the PID controller 50 to lower the injection rate of carbon dioxide. The PID controller 50 then signals the proportional control valve 42 to reduce or increase the flow of carbon dioxide.

A water resistivity control system was built in accordance with the present invention and tested to verify its advantageous features. The flow switch was manufactured by Thomas Products Ltd. model no. 1100. The static mixer was manufactured by Chemineer, Inc. and was constructed of PVC having an inside diameter of 1.476 inches and a length of 15.38 inches. The proportional control valve was manufactured by MKS Instruments, model no. 248A/B/C with a type 1249 driver module. The PDI controller was manufactured by Yokogawa Electric Corp., model no. UT 550. The inert media in the contact chamber was manufactured by the FINA Oil & Chemical Co., part no. 3620WZ. The resistivity monitor was manufactured by the Myron L Co., model 750. The porous high density polyethylene diffuser tube 30 of the diffuser injector 10 was manufactured by Porex Technologies. The diffuser tube 30 included a pore size in the 10-20 micron range.

The parameters of the test were as follows:
Inlet water flow: 20 gpm +/− 3 gpm
Inlet water pressure: 50 psi +/− 3 psi
Inlet water resistivity: 18 MegOhm +/− 3 MegOhm
Outlet water resistivity: 0.5 MegOhm +/− 0.1 MegOhm
Carbon dioxide injection pressure: 65 psi +/− 2 psi

This system operated satisfactorily and was found to have the following advantages over conventional systems being observed. Product water resistivity was controlled within a narrow resistivity limit on a steady state basis. It is believed that the present invention can provide constant product water quality, or resistivity, within 10% of the set point value.

Furthermore, the resistivity control system of the present invention is capable of adjusting to sudden changes in resistivity. It has been found that the set point can be attained within less than ten minutes from which it is changed.

In addition, it is believed that the present invention is capable of handling larger flow rates and a wider range of flow rates in one system, as hereinabove described, than what has been achieved in conventional systems. It is believed that the water resistivity control system shown in FIG. 1 can process about 10 to 40 gallons per minute. This is substantially more than what conventional systems have been able to process, which, it is believed, are limited to about nine gallons per minute per carbon dioxide injector unit. Furthermore, the water resistivity control system of the present invention is suitable for both small and large applications. For example, a small factory may require a 10 gallon per minute water resistivity control system, and a relatively larger factory may require a 40 gallon per minute control system. Use of a conventional injector unit would require 4 or 5 units being placed in parallel in order to properly treat the larger factory's requirements. The present invention can operate in either capacity with use of one system.

1. A water resistivity control system, comprising:
a) structure defining a system flow path extending from an inlet to an outlet;
b) an injector/diffuser unit disposed in said flow path and operative to inject CO₂ gas into water flowing through said injector/diffuser unit, said injector/diffuser unit including a porous member having a wall portion disposed in a passage through which water flows;
c) a sensor for monitoring the resistivity of water flowing at a location downstream of said diffuser/injector unit; and
d) a controller responsive to said sensor and operative to control the flow of CO₂ gas into said injector/diffuser unit as a function of the resistivity of water flowing at said downstream location.

2. The water resistivity control system of claim 1, wherein said injector/diffuser unit includes a porous tube disposed in said flow path such that CO₂ emitted from said porous tube intermixes with water flowing through said unit.

3. The water resistivity control system of claim 1, further comprising a contact tank located intermediate said injector/diffuser unit and said outlet, said contact tank defining a contact flow path from a tank inlet to a tank outlet, said flow path containing a substantially inert material for inhibiting the direct flow of water, along a rectilinear path, from said inlet to said outlet.

4. The water resistivity control system of claim 3, further comprising a static mixer located intermediate said injector/diffuser unit and said contact tank for promoting the mixing and dissolving of CO₂ gas injected by said injector/diffuser unit, with water flowing along said system flow path.

5. The water resistivity control system of claim 2, wherein said injector/diffuser unit includes a first port in fluid communication with said inlet and a second port through which water is discharged from said unit, said first and second ports communicating with respective mutually orthogonal first and second bores, said porous tube being located such that its axis is substantially parallel with one of said bores.

6. The water resistivity control system of claim 1, wherein said controller is operatively connected to a proportional valve that is in fluid communication with a source of CO₂ gas.

7. The apparatus of claim 1, further comprising a flow switch for detecting a predetermined minimum flow of water at said inlet and operative to enable operation of said injector/diffuser unit.

8. The water resistivity control system of claim 5, wherein the axis of said porous tube is substantially parallel with an axis of said second bore.

9. A method for controlling the resistivity of water flowing along a flow path, comprising:
a) providing an injector/diffuser unit intermediate an inlet for receiving water to be treated and an outlet for discharging treated water, said injector/diffuser unit including an injector member having a porous wall portion in fluid contact with water flowing in said unit;
b) communicating a source of CO₂ gas with said injector member;
c) monitoring the resistivity of water flowing downstream of said injector/diffuser unit; and
d) adjusting the flow of CO₂ gas to said injector member as a function of resistivity of water measured at said downstream location.

10. The method of claim 9, comprising the steps of:
a) directing water flowing from said inject or diffuser unit into a contact tank having a tank inlet and tank outlet; and
b) partially obstructing the flow of water through said tank in order to inhibit the rectilinear flow of water from said tank inlet to said tank outlet.

11. A water resistivity control system, comprising:
a) structure defining a system flow path extending from an inlet to an outlet;
b) an injector/diffuser unit disposed in said flow path and operative to inject CO₂ gas into water flowing through said injector/diffuser unit;
c) a sensor for monitoring the resistivity of water flowing at a location downstream of said diffuser/injector unit;
d) a controller responsive to said sensor and operative to control the flow of CO₂ gas into said injector/diffuser unit as a function of the resistivity of water flowing at said downstream location; and
e) a mixer located intermediate the injector/diffuser unit and said outlet, said mixer unit operative to promote the dissolving of CO₂ gas into the water.

12. An apparatus for controlling the resistivity of water, comprising:
a) a diffuser injector for mixing water and carbon dioxide gas; said diffuser injector having an inlet conduit through which water to be treated is communicated, an output conduit from which water that is mixed with carbon dioxide gas is discharged, and a carbon dioxide diffuser tube for injecting carbon dioxide gas into the water;
b) a carbon dioxide supply source for communicating carbon dioxide to said carbon dioxide diffuser tube;
c) a mixer unit serially connected to said output conduit of said diffuser injector for intermingling the water and carbon dioxide gas that exits said output conduit; and
d) a resistivity monitor for measuring the resistivity of the water and carbon dioxide mixture and transmitting a signal to said carbon dioxide supply source for adjusting the amount of carbon dioxide to be communicated to said diffuser injector.

13. The apparatus of claim 12, wherein said mixer unit comprises a static mixer for further intermingling the water and carbon dioxide gas.

14. The apparatus of claim 12, wherein said mixer unit comprises a static mixer for further intermingling the water and carbon dioxide gas and a serially connected contact chamber for further enhancing the stability in the resistivity level of the water.

15. The apparatus of claim 14, wherein said contact chamber contains a thermoplastic media for further mixing and dissolving the carbon dioxide into the water.

16. The apparatus of claim 15, wherein said thermoplastic media comprises a plurality of polypropylene beads.

17. The apparatus of claim 12, wherein said diffuser injector is generally T-shaped so that said inlet conduit forms a right angle relative to said output conduit.

18. The apparatus of claim 12, wherein said carbon dioxide diffuser tube is made of a porous thermoplastic material.

19. The apparatus of claim 12, wherein said carbon dioxide diffuser tube defines a plurality of microporous openings for dispersing and diffusing the carbon dioxide gas into the water.

20. The apparatus of claim 12, wherein said carbon dioxide diffuser tube is disposed transverse to said input conduit and coaxially with respect to said output conduit.

21. The apparatus of claim 12, wherein said carbon dioxide diffuser tube is secured within said output conduit by means of an insert.

22. The apparatus of claim 12, wherein said carbon dioxide supply source includes a carbon dioxide storage tank.

23. The apparatus of claim 12, wherein said carbon dioxide supply source includes a proportional control valve for adjusting the flow of carbon dioxide to said diffuser injector in response to signals from said resistivity monitor.

24. The apparatus of claim 23, wherein said carbon dioxide supply source includes a controller for receiving and converting signals transmitted by said resistivity monitor and sending a corrective signal to said proportional control valve to proportionately adjust the injection rate of carbon dioxide gas into said diffuser injector.

25. A method for reionizing water, comprising the steps of:
a) providing a diffuser injector having an inlet conduit, an output conduit, and a microporous diffuser tube disposed coaxially within said output conduit;
b) communicating water into said inlet conduit of said diffuser injector and communicating carbon dioxide gas from a carbon dioxide supply source into said microporous diffuser tube;
c) injecting and dispersing the carbon dioxide gas through said microporous diffuser tube and into the water communicated through said output conduit;
d) discharging the mixture of water and carbon dioxide gas from said output conduit and intermingling the mixture in a mixer unit;
e) communicating the water and carbon dioxide gas mixture from the mixer unit to a resistivity monitor;
f) measuring the resistivity of the water and carbon dioxide gas mixture and transmitting a signal to said carbon dioxide supply source; and
g) adjusting the amount of carbon dioxide gas to be communicated to said diffuser tube as a function of the signal transmitted to said carbon dioxide supply source.

26. The method of claim 25, wherein said adjusting step comprises the steps of providing a controller and a proportional control valve; receiving signals into said controller transmitted by said resistivity monitor; converting the signals and sending a corrective signal to the proportional control valve to proportionately adjust the injection rate of carbon dioxide gas into said diffuser tube.

27. The method of claim 25, wherein said intermingling step includes communicating the water and carbon dioxide gas mixture to a static mixer; further mixing and dissolving the carbon dioxide gas into the water; communicating the mixture from the static mixer to a contact chamber; further intermingling the carbon dioxide gas and the water; removing substantially all of the bubbles contained in the mixture.

28. A method for reionizing water, comprising the steps of:
a) providing a diffuser injector having an inlet conduit, an output conduit, and a microporous diffuser tube disposed coaxially within said output conduit;
b) communicating water into said inlet conduit of said diffuser injector and communicating water soluble gas from a gas supply source into said microporous diffuser tube;
c) injecting and dispersing the water soluble gas through said microporous diffuser tube and into the water communicated through said output conduit;
d) discharging the mixture of water and gas from said output conduit and intermingling the mixture in a mixer unit;
e) communicating the water and gas mixture from the mixer unit to a resistivity monitor;
f) measuring the resistivity of the water and gas mixture and transmitting a signal to said gas supply source; and
g) adjusting the amount of water soluble gas to be communicated to said diffuser tube as a function of the signal transmitted to said gas supply source.

29. The method of claim 25, wherein said water soluble gas is carbon dioxide.

30. An apparatus for controlling the resistivity of water, comprising:
a) a diffuser injector for mixing water and a water soluble gas, said diffuser injector having an inlet conduit through which water to be treated is communicated, an output conduit from which water that is mixed with a water soluble gas is discharged, and a gas diffuser tube for injecting a water soluble gas into the water;
b) a gas supply source for communicating a water soluble gas to said gas diffuser tube;
c) a mixer unit serially connected to said output conduit of said diffuser injector for intermingling the water and said water soluble gas that exits said output conduit; and
d) a resistivity monitor for measuring the resistivity of the water and gas mixture and transmitting a signal to said gas supply source for adjusting the amount of said water soluble gas to be communicated to said diffuser injector.

31. The apparatus of claim 30, wherein said water soluble gas is carbon dioxide gas.
